(19) United States
(12) Patent Application Publication
(10) Pub. No.: US 2014/0126726 A1
(43) Pub. Date: May 8, 2014

(54) ENHANCED STEREOPHONIC AUDIO RECORDINGS IN HANDHELD DEVICES

(71) Applicant: DSP Group, Herzelia (IL)

(72) Inventors: Arie Heiman, Sde Warburg (IL); Moshe Haiut, Ramat Gan (IL); Uri Yehuday, Tel Aviv (IL)

(73) Assignee: DSP Group, Herzelia (IL)

(21) Appl. No.: 14/074,405

(22) Filed: Nov. 7, 2013

Related U.S. Application Data
(60) Provisional application No. 61/723,797, filed on Nov. 8, 2012.

(51) Int. Cl. H04R 3/00; H04R 5/04

(52) U.S. Cl. CPC H04R 3/005; H04R 5/04
USPC 381/26

(57) ABSTRACT

Methods and systems are provided for enhanced stereo audio recordings in electronic devices. Stereophonic recording performance in an electronic device, using a first microphone and a second microphone in the electronic device, may be assessed; and processing of signals generated by the first microphone and the second microphone may be configured based on the assessed stereophonic recording performance. The configuring may comprises adaptively modifying the processing to enhance stereophonic recording performance, to match or approximate an ideal performance. The assessing of the stereophonic recording in the electronic device may be based on a type of each of the first microphone and the second microphone, and/or based on a spacing therebetween. The processing may be adaptively modified to simulate directional reception of signals by the first microphone and the second microphone when the microphones are omnidirectional.

### CLAIM OF PRIORITY

This patent application makes reference to, claims priority to and claims benefit from the U.S. Provisional Patent Application Ser. No. 61/723,797, filed on Nov. 8, 2012, and having the title “Enhanced Stereo Audio Recordings in Handheld Devices.” The above stated application is hereby incorporated herein by reference in its entirety.

### TECHNICAL FIELD

Aspects of the present application relate to audio processing. More specifically, certain implementations of the present disclosure relate to enhanced stereophonic audio recordings in handheld devices.

### BACKGROUND

Existing methods and systems for managing audio input/output components (e.g., speakers and microphones) in electronic devices may be inefficient and/or costly. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for enhanced stereophonic audio recordings in handheld devices, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF THE DRAWINGS

FIG. 1 illustrates an example electronic device with two microphones facing the same direction.

FIG. 2 illustrates examples of handheld devices with two microphones facing the same direction, and spaced close to each other.

FIG. 3 illustrates architecture of an example electronic device with a plurality of microphones, configurable to support enhanced stereophonic audio recordings.

FIG. 4 illustrates example recording scenario in an electronic device having two omnidirectional microphones facing the same direction.

FIG. 5 is a flowchart illustrating an example process for enhanced stereophonic audio recordings.

### DETAILED DESCRIPTION

Certain implementations may be found in method and system for enhanced stereophonic audio recordings in electronic devices, particularly in handheld devices. As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

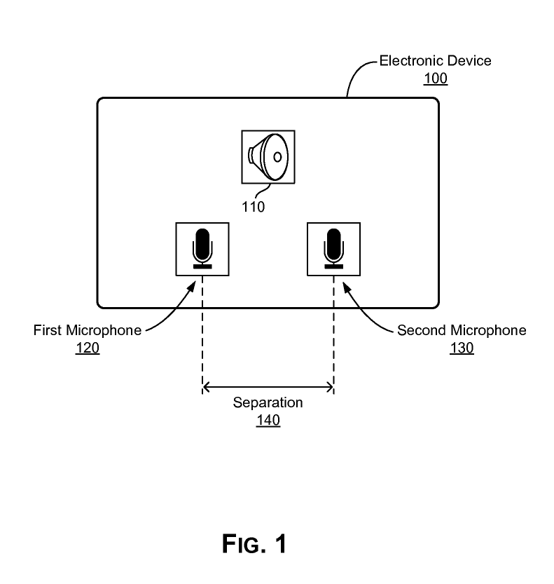

FIG. 1 illustrates an example electronic device with two microphones facing the same direction. Referring to FIG. 1, there is shown an electronic device 100.

The electronic device 100 may comprise suitable circuitry for performing or supporting various functions, operations, applications, and/or services. The functions, operations, applications, and/or services performed or supported by the electronic device 100 may be run or controlled based on user instructions and/or pre-configured instructions.

In some instances, the electronic device 100 may support communication of data, such as via wired and/or wireless connections, in accordance with one or more supported wireless and/or wired protocols or standards.

In some instances, the electronic device 100 may be a handheld device—i.e. intended to be held by a user during use of the device, allowing for use of the device on the move and/or at different locations. In this regard, the electronic device 100 may be designed and/or configured to allow for ease of movement, such as to allow it to be readily moved while being held by the user as the user moves, and the electronic device 100 may be configured to perform at least some of the operations, functions, applications and/or services supported by the device on the move. Examples of electronic devices that are handheld devices comprise communication mobile devices (e.g., cellular phones, smartphones, and/or tablets), computers (e.g., laptops), media devices (e.g., portable media players and cameras), and the like. The electronic device 100 may even be a wearable device—i.e., may be worn by the device's user rather than being held in the user's hands. Examples of wearable electronic devices may comprise digital watches and watch-like devices (e.g., iWatch). The disclosure, however, is not limited to any particular type of electronic device.

The electronic device 100 may support input and/or output of audio. The electronic device 100 may incorporate, for example, a plurality of speakers and microphones, for use in outputting and/or inputting (capturing) audio, along with suitable circuitry for driving, controlling and/or utilizing the speakers and microphones. As shown in FIG. 1, for example, the electronic device 100 may comprise a speaker 110 and a pair of microphones 120 and 130. The speaker 110 may be used in outputting audio (or other acoustic) signals from the electronic device 100; whereas the microphones 120 and 130 may be used in inputting (e.g., capturing) audio or other acoustic signals into the electronic device. The use of two microphones (120 and 130) may be desirable as it may allow for supporting stereophonic effects. In this regard, the human brain may experience a stereophonic effect when a common signal is received and/or captured by both ears with some difference in amplitude and phase. The stereophonic effect may then occur due to the fact that the two ears are located at a distance between each other and have opposite directions in their selective sensitivity—i.e., depending on the location of the signal source, one ear may capture the sound earlier and stronger than the other ear. While the phase difference generally has a limited effect on the stereophonic experience (it is restricted to the lower frequency domain), the amplitude difference may be the more important attribute to affect this experience. Thus, in order to conserve stereophonic effects during recordings (e.g., by electronic devices, such as the electronic device 100), two microphones may be used, and placed specifically for that purpose. In particular, the microphones may be placed such that they may receive signals from the same source (e.g., by placing them on the same side or surface of the electronic device, or case thereof), and/or locating them with some distance between them (separate distance 140) that is sufficient to imitate reception (of audio) by the human ears. To achieved optimal stereophonic recording performance, microphones may need to be arranged in particular manner (e.g., being spaced apart at significant distance—e.g., 15 cm, and/or having directional reception characteristics).

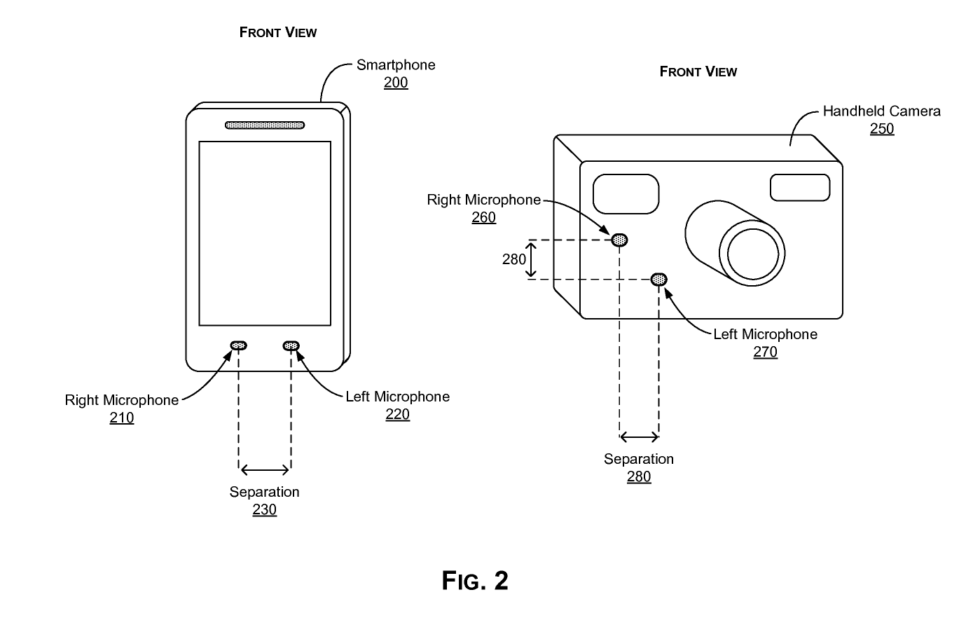

In some instances, it may be desirable to arrange microphones so that they are close to one another. For example, in mobile communication devices, the microphones that are intended for use in audio recording may also be used in supporting such functions as, for example, noise reduction. The use of advanced noise reduction techniques in mobile communication devices may incorporate, for example, use of two microphones that may be used in picking up ambient noise. In some instances, the performance of noise reduction would generally be best when the two microphones are placed close to each other (e.g., in the range of 1-2 cm), such as to ensure that correlation between the noise that is picked up in both microphones is significantly higher, and thus the performance of the noise reduction with the two microphones may be significantly better. Arrangements of microphones in such manner (e.g., by having the microphones placed close to one another), whether to enhance other functions like noise reduction or because of space limitation, may be particularly done in certain types of electronic devices—e.g., mobile communication devices and other handheld electronic devices. Examples of such devices are shown in, for example, FIG. 2.

Such arrangements of microphones, however, may degrade performance of stereophonic recording—e.g., due to poor differentiation between the two microphones as a result of them being placed too close to one another for stereophonic recording purposes. Accordingly, in various implementations in accordance with the present disclosure, stereophonic recording may be enhanced in devices having microphones that are not optimally place—e.g., being too close to one another, such as in the range of 1-2 cm. The enhancing of stereophonic recording may be achieved by use of, for example, adaptive processing that may allow for simulating results that would normally be achieved by use of microphones in optimal arrangements—e.g., spaced apart and/or have directional reception characteristics. This is described in more detail in connection with the following figures.

FIG. 2 illustrates examples of handheld devices with two microphones facing the same direction, and spaced close to each other. Referring to FIG. 2, there is shown a smartphone 200 and a handheld camera 250.

Each of the smartphone 200 and the handheld camera 250 may incorporate multiple microphones (e.g., two) to support stereophonic audio recordings. For example, smartphone 200 comprises a pair of microphones 210 and 220 (arranged as right and left microphones, respectively), and handheld camera 250 comprises a pair of microphones 260 and 270 (arranged as right and left microphones, respectively). Nonetheless, while the two microphones in each of the smartphone 200 and the handheld camera 250 are shown as being on the same side, the disclosure is not so limited. Rather, it should be understood that in instances the two microphones may be located on different sides of the devices—e.g., be located such that one microphone (e.g., microphone 210) may be on the front side of the smartphone 200 while the other microphone (e.g., microphone 220) may be located on the back of the smartphone 200, but with the two microphones still being close to one another (e.g., both at the bottom portion of the phone). The microphones (microphones 210 and 220 in the smartphone 210 and microphones 260 and 270 in the handheld camera 250) may be used in generating audio recordings that are intended to capture environmental sounds that may come from various sources (e.g., at distances between zero to several meters). The recordings may be done in conjunction with other operations in the devices (e.g., during video capture).

In some instances, however, relatively small dimensions of certain handheld devices, as well as design considerations, may limit the physical spacing between the microphones, necessitating placement of the microphones close to one another. Because of limited physical space and/or a desire to optimize particular functions (e.g., noise reduction) in such handheld devices as smartphones and portable handheld cameras, for example, the spacing between the microphones in the smartphone 200 and the camera 250 (e.g., separation 230 between microphones 210 and 220 in the smartphone 210, and separation 280 between microphones 260 and 270 in the handheld camera 250) may be relatively small. For example, in both of the smartphone 200 and the camera 250, the microphones incorporated therein may be identical omnidirectional microphones that are located on the front plan of the device, at a small horizontal distance from each other. For example, microphones 210 and 220 of the smartphone 200 may be placed in the bottom of the front plane, aligned on an horizontal line with a separation distance (230) of 1 cm between them; while microphones 260 and 270 of the camera 250 may be located in a diagonal direction such that they may have horizontal separation distance (280) of 1 cm between them in both Portrait and Landscape shooting modes. The small spacing between two microphones in each of the smartphone 200 and the camera 250 (as well as their type—that is being ‘omnidirectional’ microphones) may cause poor differentiation between the two microphones.

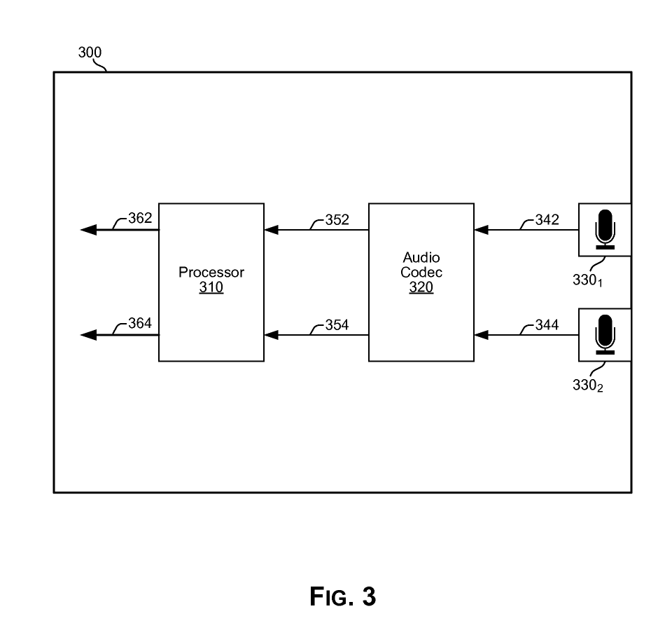

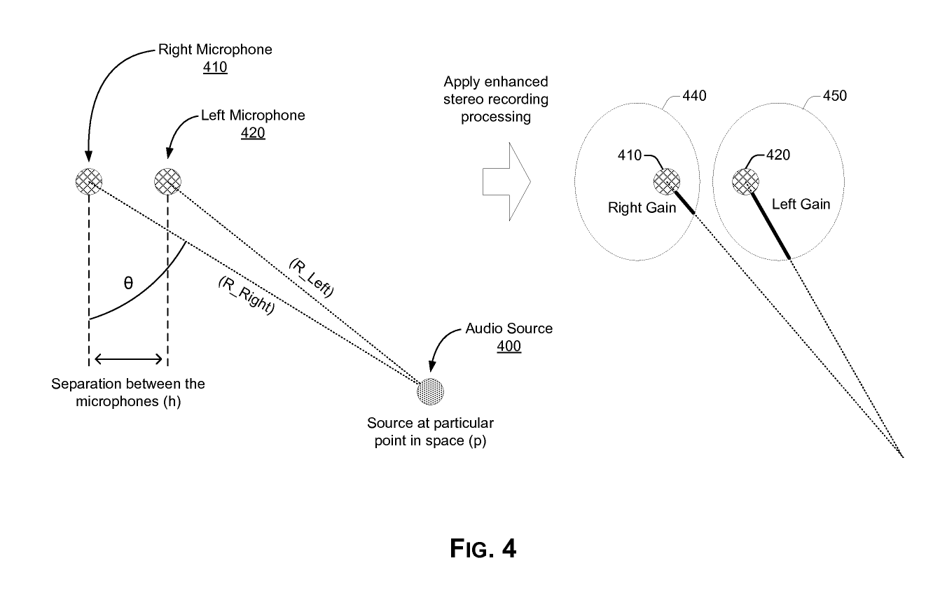

Accordingly, in various implementations, devices supporting stereophonic recording but having microphone arrangements that may degrade stereophonic recording performance may incorporate adaptive architecture and/or functions for enhancing stereophonic recording. The stereophonic recording enhancement may be achieved by, for example, use of adaptively modified digital processing that may be applied to signals coming from close microphone pairs, to produce two new output signals with enhanced stereophonic effects. Thus, the use of the adaptive modified digital processing in this manner may allow use of two microphones that may be positioned too close to one another (e.g., about 1-2 cm) to produce audio with stereophonic effect that may be comparable to the stereophonic effect of a recording with two microphones that are positioned optimally far apart for stereophonic recording (e.g., 15 cm). In one example implementation, audio signals arriving from different directions and captured by the close microphone pairs may have appropriate intensity that depends on the direction of arrival on each one of the two output signals. Thus, the individual directions may be clearly recognized by human ears during playback. Due to the small distance between the microphones, the amplitudes of the two original input signals do not significantly differ from each other. Accordingly, a small phase difference of the input signals may be converted, with the application of adaptive processing, into a significant amplitude difference between the two output signals. An example architecture (and adaptive processing applicable thereby) is described in more detail with respect to FIGS. 3 and 4.

FIG. 3 illustrates architecture of an example electronic device with a plurality of microphones, configurable to support enhanced stereophonic audio recordings. Referring to FIG. 3, there is shown an electronic device 300.

The electronic device 300 may be similar to the electronic device 100 of FIG. 1. In this regard, the electronic device 300 may be configured to support audio input and/or output operations. The electronic device 300 may comprise, for example, a plurality of audio input and/or output components. For example, electronic device 300 may comprise microphones 330₁ and 330₂. Further, the electronic device 300 may also incorporate circuitry for supporting audio related processing and/or operations. For example, the electronic device 300 may comprise a processor 310 and an audio codec 320.

The processer 310 may comprise suitable circuitry configurable to process data, control or manage operations (e.g., of the electronic device 300 or components thereof), perform tasks and/or functions (or control any such tasks/functions). The processor 310 may run and/or execute applications, programs and/or code, which may be stored in, for example, memory (not shown). Further, the processor 310 may control operations of electronic device 300 (or components or subsystems thereof) using one or more control signals. The processor 310 may comprise a general purpose processor, which may be configured to perform or support particular types of operations (e.g., audio related operations). The processor 310 may also comprise a special purpose processor. For example, the processor 310 may comprise a digital signal processor (DSP), a baseband processor, and/or an application processor (e.g., an ASIC).

The audio codec 320 may comprise suitable circuitry configurable to perform voice coding/decoding operations. For example, the audio codec 320 may comprise one or more analog-to-digital converters (ADCs), one or more digital-to-analog converters (DACs), and one or more multiplexers (mux), which may be used in directing signals handled in the audio codec 320 to appropriate input and output ports thereof.

In operations, the electronic device 300 may support inputting and/or outputting of audio signals. For example, the microphone 330₁ and 330₂ may capture audio, generating corresponding analog audio input signals (e.g., analog signals 342 and 344), which may be forwarded to the audio codec 320. The audio codec 320 may convert the analog audio input (e.g., via the ADCs) to a digital audio signals (e.g., signals 352 and 354), which may be transferred to the processor 310 (e.g., over I²S connections). In some instances, however, the analog-to-digital conversions (and thus the audio codec 320 if that was the only reason it was utilized) may be bypassed with the signals being fed directly from the microphone 330₁ and 330₂ to the processor 310—e.g., if the microphone 330₁ and 330₂ were digital microphones. The processor 310 may then apply digital processing to the digital audio signals.

In some instances, the processor 310 may be configured to support stereophonic recordings. Accordingly, in some instances the processor 310 may generate, based on processing on audio input signals generated by the microphones 330₁ and 330₂, left-side signal 362 and right-side signal 364 (i.e., signals intended for each of a listener's left and right ears, respectively, which when received by the ears allow for generating stereophonic effect in the brain). The stereophonic recording performed in the electronic device 300 may, however, be degraded due to microphone arrangements utilized thereon. For example, the microphone 330₁ and 330₂ may be implemented as omnidirectional microphones (i.e., configured for receiving ambient audio from wide range rather than over narrow beams), and/or may be placed too close to one another (e.g., only 1-2 cm apart)—e.g., due to lack of space in the electronic device 300 and/or to enable optimal noise reduction processing.

Accordingly, in various implementations, the electronic device 300 may be configured for supporting enhanced audio recordings. The enhanced stereophonic recording may be used to overcome shortcomings or deficiencies in stereophonic recording that may be caused by less-than-optimal placement of the microphones (e.g., microphones 330₁ and 330₂) or characteristics thereof. The enhanced stereophonic recording may be achieved by using, for example, adaptive enhancement functions that are performed (e.g., in the processor 310) during processing of input audio signals (i.e., signals captured by the microphones). Thus, the architecture of the electronic device 300 may be particularly modified to enable or support these functions, and/or to allow performing them when needed. An example of adaptive processing that may be implemented in the electronic device (e.g., via the processor 310) is described in more detail with respect to FIG. 4.

Similar architecture and/or functions as described with respect to the electronic device 300 may be utilized in devices having microphone arrangements posing similar shortcomings with respect to stereophonic recording and such requiring enhanced stereophonic recording—e.g., handheld devices with closely placed (and typically omnidirectional) microphones, such as the smartphone 200 and the camera 250.

FIG. 4 illustrates example recording scenario in an electronic device having two omnidirectional microphones facing the same direction. Referring to FIG. 4, there is shown a pair of closely spaced omnidirectional microphones 410 and 420.

The omnidirectional microphones 410 and 420 may correspond to microphones in a handheld device (e.g., microphones 210 and 220 of the smartphone 200). Because the omnidirectional microphones 410 and 420 may be spaced too close for optimal stereophonic recording, the differentiation between signals received by these microphones from a single audio source (e.g., source 400) may not result in satisfactory stereophonic effect when subjected to normal processing. Accordingly, the signals may be processed using a processor (e.g., the processor 310) which may be configured to incorporate processing modified to provide enhanced stereophonic recording.

For example, as shown in FIG. 4, the microphones 410 and 420 may capture signals corresponding to audio—e.g., sound S(t), originating at the audio source 400 that is located at particular point (P) of space in front of the two microphones. Because the system may be additive, there is no constraint for audio source 400 to be the single audio source in the system. Depending on the angle in which the point P is observed by the microphones 410 and 420, there is some difference between the individual distances from the point P to each microphone—shown in FIG. 4 as distances R_left and R_right. The difference between the distances R_left and R_right may lead to an appropriate difference between the delays D_left and D_right, as well as a slight difference in the gains G_left and G_right for the signals received by each of the microphones 410 and 420. The two delays and the two gains may be fully determined as functions of the audio source distance R, the spacing between microphones h, and the viewing angle θ of the audio source. G0 denotes the initial gain at the location of the audio source. For example, the gains (G_left and G_right) and delays (D_left and D_right) may be determined based on the following equations:

G=G0/R (1)

D=R/V (2)

Where ‘R’ corresponds to the actual distance from the source (i.e., R corresponds to each of R_right and R_left for each of the right and left microphones 410 and 420), and V is the applicable propagation speed of sound.

Accordingly, the audio channels corresponding to signals captured by each of the right and left microphones 410 and 420 may be represented as:

S_left(t)=G_left*S(t−D_left) (3)

S_right(t)=G_right*S(t−D_right) (4)

The processor (e.g., the processor 310) may then apply the enhanced stereophonic recording processing. The processor 310 may use the small phase difference between the microphones 410 and 420 to produce a noticeable gain difference between the two output signals, which may depend on the direction of arrival of the sound. Thus, the individual directions can be clearly recognized by the human ears during playback. Various enhancement processing schemes may be utilized. For example, in the example implementation shown in FIG. 4, the processing that produces the gain difference between Left and Right channels (i.e., signals 362 and 364) may be done such that each one of the two omnidirectional microphones may be turned into an un-balanced directional microphone. This may be achieved by using the following formula for the left output channel and right output channel:

S_left(t)=G0*M_left(t)−G1*M_right(t−d) (5)

S_right(t)=G0*M_right(t)−G1*M_left(t−d) (6)

Where M_left(t) and M_right(t) are the signals that are simultaneously captured by the two microphones; and constants G0, G1, and d may relate to a virtual audio source that comes from the right side (i.e., when θ=−90°).

For example, the delay d in this case depends only on the space h between the two microphones, and may be pre-calculated and used as a constant. The values G0 and G1 are also constants, and are pre-calculated assuming a certain ‘desired’ distance h′ that is much bigger than h (e.g., 100 cm). In an example use scenario, d may be determined as h/V (where V is the speed of sound). Thus for h=1 cm (and assuming V is 343.2 m/s), d would be ≈29 us. G0 may be set to 1, whereas G1 may be set to h′/(h+h′). Thus, with h of 1 cm and h′ set to 100 cm, G1 would be ≈0.99. The processing done in the manner described above may result in a directional effect in each channel (as shown in FIG. 4). For example, audio sources that are located in the opposite side of the channel are fully decayed while audio sources that are located in the appropriate channel side are amplified. From channel recording gain aspect, the actual effect of the adaptive processing may be similar to what would be achieved if the microphones were located at a distance of up to an assumed ‘desired’ distance h′ (i.e., 100 cm) from each other.

The described process can be carried-out either in the time domain or in the spectral domain. In the time domain, the delay value d is implemented by applying an interpolation process on the sampled signal. This enables delays of sub-samples (e.g., in a 8000 sample/sec sampling rate, h=1 cm requires a delay of ˜0.25 sample). In the frequency domain, each bin of frequency ω within a time-frame is multiplied by Exp−(ω*T) to introduce a time-delay T.

One advantage of the described process is that the output stereophonic channel pair is almost of a common delay. Zero delay stereophonic pairs can be easily transferred into mono audio channels by just summing together the Left and Right channels. This is not possible in stereophonic channel pairs that introduce significant delays between the two channels (e.g. when the space between microphones is greater than 10 cm), where a simple summation usually results in a decay of certain frequencies in the audio signal. Another advantage of the described process is that multiple audio sources do not require separate processes. That is to say, a single process takes care of all simultaneous audio sources within the recorded scene. For example, with a common process an audio source from the left side will result in enhanced gain in the left channel (and low gain in the right channel), while a simultaneous second audio source from the right side will result in enhanced gain in the right channel.

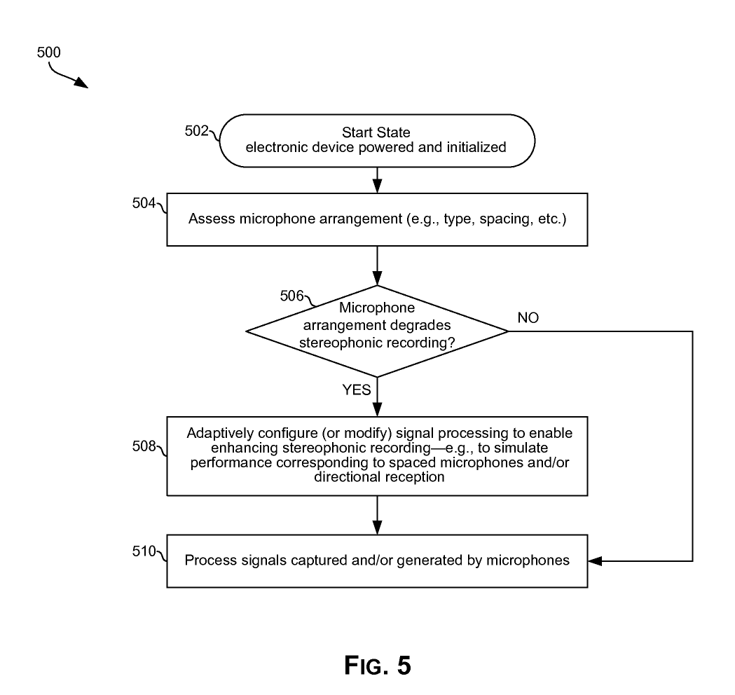

FIG. 5 is a flowchart illustrating an example process for enhanced stereophonic audio recordings. Referring to FIG. 5, there is shown a flow chart 500, comprising a plurality of example steps, which may executed in an electronic system (e.g., the electronic device 300 of FIG. 3), to facilitate enhanced stereophonic audio recordings using two closely spaced, and similarly facing, omnidirectional microphones incorporated into the electronic system.

In starting step 502, an electronic device (e.g., the electronic device 300) may be powered on and initialized. This may comprise powering on, activating and/or initializing various components of the electronic device, such that the electronic device may be ready to perform or execute functions or application supported thereby.

In step 504, the microphone arrangement in the electronic device may be assessed—e.g., particularly with respect to stereophonic recording. In this regard, certain microphone arrangements (e.g., two omnidirectional microphones that are spaced too close to one another) may degrade performance of stereophonic recordings. Therefore, assessing the microphone arrangement may comprise determining (or estimating) performance of stereophonic recording done using the microphones. The estimated performance may be estimated in terms of anticipated quality of stereophonic effects of audio content produced based on signals captured via the microphones.

The outcome of the assessment may be checked in step 506. In this regard, the checking may comprise comparing the assessed performance against one or more predefined thresholds, which may be related to (or calculated based on) quality of stereophonic effects in anticipated output audio. For example, quality of stereophonic effect may be expressed as a percentage (with 100% corresponding to ideal quality of stereophonic effect), with the thresholds being set as particular percentages (e.g., 50%, 75%, 90%, etc.). Thus, a minimal ‘acceptable’ quality may be set to, e.g., 90% to indicate that only recordings with stereophonic effect having quality of less than 90% would be considered degraded. In some implementations, however, the adaptive processing may be done at all time, being adjusted dynamically to always ensure achieving (or attempt to achieve) ideal performance. In instances where it may be determined that the microphone arrangement does not degrade stereophonic recording, the process may proceed to step 510. Alternatively, in instances where it may be determined that the microphone arrangement may degrade stereophonic recording, the process may proceed to step 508.

In step 508, signal processing may be adaptively configured (or modified), to enable enhancing stereophonic recording—e.g., to simulate performance corresponding to spaced microphones and/or directional reception. For example, the processing of input signals captured by the microphones may be adaptive modified similar to the processing described with respect to FIG. 4, for example.

In step 510, input signals captured (or generated) by the microphones may be processed. The resultant signals (corresponding to left and right channels) may provide desirable stereophonic effects, either based on the microphones suitable arrangement or as result of the adaptive processing performed when the microphone arrangement is less than optimal.

In some implementations, a method for enhancing stereophonic recording may be used in a system that may comprise an electronic device (e.g., electronic device 300), which may comprise one or more circuits (e.g., processor 310 and audio codec 320) and a first microphone and a second microphone (e.g., microphones 330₁ and 330₂). The method may comprise assessing stereophonic recording performance in the electronic device using the first microphone and the second microphone; and configuring processing of signals generated by the first microphone and the second microphone, based on the assessed stereophonic recording performance, wherein the configuring comprises adaptively modifying the processing to enhance stereophonic recording performance, to match or approximate an ideal performance. The method may further comprise generating, based on the processing of signals generated by the first microphone and the second microphone, a left channel signal and a right channel signal, for outputting to a listener's left and right ears, respectively. The method may comprise adaptively modifying the processing when the assessed stereophonic recording performance falls below a predetermined threshold. The method may comprise assessing the stereophonic recording in the electronic device based on a type of each of the first microphone and the second microphone, and/or based on a spacing between the first microphone and the second microphone. The electronic device may comprise a handheld device. The method may comprise adaptively modifying the processing based on a distance between the first microphone and the second microphone, a distance from a source of signals captured by the first microphone and the second microphone, an initial gain at a location of the source of signals, and/or audio propagation speed. The method may comprise generating, based on the adaptive modifying of the processing, noticeable gain difference between two output signals corresponding to signals captured by each of the first microphone and the second microphone. The method may comprise adaptively modifying the processing to simulate directional reception of signals by the first microphone and the second microphone when the microphones are omnidirectional. The simulating of directional reception may result in amplifying audio sources that are located in an appropriate channel side are amplified. The simulating of directional reception may result in fully decaying audio sources that are located in an opposite side of a channel.

In some implementations, stereophonic recording may be enhanced in a system that may comprise an electronic device (e.g., electronic device 300), which may comprise one or more circuits (e.g., processor 310 and audio codec 320) and a first microphone and a second microphone (e.g., microphones 330₁ and 330₂). The one or more circuits may be operable to assess stereophonic recording performance in the electronic device using the first microphone and the second microphone; and configure processing of signals generated by the first microphone and the second microphone, based on the assessed stereophonic recording performance, wherein the configuring comprises adaptively modifying the processing to enhance stereophonic recording performance, to match or approximate an ideal performance. The processing may comprise generating a left channel signal and a right channel signal, for outputting to a listener's left and right ears, respectively. The one or more circuits may be operable to adaptively modify the processing when the assessed stereophonic recording performance falls below a predetermined threshold. The one or more circuits may be operable to assess the stereophonic recording in the electronic device based on a type of each of the first microphone and the second microphone, and/or based on a spacing between the first microphone and the second microphone. The electronic device may comprise a handheld device (e.g., smartphone 200 or camera 250). The one or more circuits may be operable to adaptively modify the processing based on a distance between the first microphone and the second microphone, a distance from a source of signals captured by the first microphone and the second microphone, an initial gain at a location of the source of signals, and/or audio propagation speed. The one or more circuits may be operable to adaptively modify the processing to generate noticeable gain difference between two output signals corresponding to signals captured by each of the first microphone and the second microphone. The one or more circuits may be operable to adaptively modify the processing to simulate directional reception of signals by the first microphone and the second microphone when the microphones are omnidirectional. The simulating of directional reception may result in amplifying audio sources that are located in an appropriate channel side are amplified. The simulating of directional reception may result in fully decaying audio sources that are located in an opposite side of a channel.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for enhanced stereophonic audio recordings in handheld devices.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein. Another typical implementation may comprise an application specific integrated circuit or chip.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form. Accordingly, some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A system, comprising:
an electronic device comprising one or more circuits and a first microphone and a second microphone, the one or more circuits being operable to:
assess stereophonic recording performance in the electronic device using the first microphone and the second microphone; and
configure processing of signals generated by the first microphone and the second microphone, based on the assessed stereophonic recording performance, wherein the configuring comprises adaptively modifying the processing to enhance stereophonic recording performance, to match or approximate an ideal performance.

2. The system of claim 1, wherein the processing comprises generating a left channel signal and a right channel signal, for outputting to a listener's left and right ears, respectively.

3. The system of claim 1, wherein the one or more circuits are operable to adaptively modify the processing when the assessed stereophonic recording performance falls below a predetermined threshold.

4. The system of claim 1, wherein the one or more circuits are operable to assess the stereophonic recording in the electronic device based on a type of each of the first microphone and the second microphone, and/or based on a spacing between the first microphone and the second microphone.

5. The system of claim 1, wherein the electronic device comprises a handheld device.

6. The system of claim 1, wherein the one or more circuits are operable to adaptively modify the processing based on a distance between the first microphone and the second microphone, a distance from a source of signals captured by the first microphone and the second microphone, an initial gain at a location of the source of signals, and/or audio propagation speed.

7. The system of claim 1, wherein the one or more circuits are operable to adaptively modify the processing to generate noticeable gain difference between two output signals corresponding to signals captured by each of the first microphone and the second microphone.

8. The system of claim 1, wherein the one or more circuits are operable to adaptively modify the processing to simulate directional reception of signals by the first microphone and the second microphone when the microphones are omnidirectional.

9. The system of claim 8, wherein the simulating of directional reception results in amplifying audio sources that are located in an appropriate channel side are amplified.

10. The system of claim 8, wherein the simulating of directional reception results in fully decaying audio sources that are located in an opposite side of a channel.

11. A method, comprising:
in an electronic device comprising a first microphone and a second microphone:
assessing stereophonic recording performance in the electronic device using the first microphone and the second microphone; and
configuring processing of signals generated by the first microphone and the second microphone, based on the assessed stereophonic recording performance, wherein the configuring comprises adaptively modifying the processing to enhance stereophonic recording performance, to match or approximate an ideal performance.

12. The method of claim 11, comprising generating based on the processing of signals generated by the first microphone and the second microphone, a left channel signal and a right channel signal, for outputting to a listener's left and right ears, respectively.

13. The method of claim 11, comprising adaptively modifying the processing when the assessed stereophonic recording performance falls below a predetermined threshold.

14. The method of claim 11, comprising assessing the stereophonic recording in the electronic device based on a type of each of the first microphone and the second microphone, and/or based on a spacing between the first microphone and the second microphone.

15. The method of claim 11, wherein the electronic device comprises a handheld device.

16. The method of claim 11, comprising adaptively modifying the processing based on a distance between the first microphone and the second microphone, a distance from a source of signals captured by the first microphone and the second microphone, an initial gain at a location of the source of signals, and/or audio propagation speed.

17. The method of claim 11, comprising generating, based on the adaptive modifying of the processing, noticeable gain difference between two output signals corresponding to signals captured by each of the first microphone and the second microphone.

18. The method of claim 11, comprising adaptively modifying the processing to simulate directional reception of signals by the first microphone and the second microphone when the microphones are omnidirectional.

19. The method of claim 18, wherein the simulating of directional reception results in amplifying audio sources that are located in an appropriate channel side are amplified.

20. The method of claim 18, wherein the simulating of directional reception results in fully decaying audio sources that are located in an opposite side of a channel.
